(19) United States
(12) Patent Application Publication
(10) Pub. No.: US 2026/0050528 A1
(43) Pub. Date: Feb. 19, 2026

(54) STANDARDIZATION OF DATA LOGS IN EDGE DEVICES

(71) Applicant: Dell Products L.P., Round Rock, TX (US)

(72) Inventors: ROMAN BOBER, Ashdod (IL); MAXIM BALIN, Gan-Yavne (IL); STAV SAPIR, Beer Sheva (IL)

(21) Appl. No.: 18/801,991

(22) Filed: Aug. 13, 2024

(51) Int. Cl. G06F 11/30; G06F 11/34; H04L 41/0806

(52) U.S. Cl. CPC G06F 11/3075; G06F 11/3476; H04L 41/0806

(57) ABSTRACT

Methods and systems for managing operation of a data processing system of a deployment are disclosed. The operation may be managed by enforcing a data log schema for data logs. The data log schema may be enforced by generating compliant data logs from non-compliant data logs of the data processing system. The edge orchestrator may receive the compliant data logs and search for patterns in the operation. From the patterns, an undesired behavior of the data processing system may be found. From the undesired behavior, a root cause may be discovered. Based on the root cause, a service update may be generated and transferred to the data processing system. The service update may be used to improve computer implemented services of the data processing system.

### FIELD

Embodiments disclosed herein relate generally to managing operation of a data processing system. More particularly, embodiments disclosed herein relate to generating data logs that conform to a standardized layout.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams illustrating operation of a system in accordance with an embodiment.

FIGS. 3A-3B show flow diagrams illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The operation may be managed by enforcing a data log schema for data logs generated by the data processing system. The data log schema may be enforced by using data handling rules to generate a compliant data log from a non-compliant data log. The non-compliant data log may be generated by a service on the data processing system.

Once a compliant data log is generated, the compliant data log may be transferred to an edge orchestrator. The edge orchestrator may manage operation of the data processing system of the data processing systems. The edge orchestrator may utilize data from categories and events from event logs to find patterns in the operation of the data processing system.

The patterns may be used to diagnose an undesired behavior of the data processing system. Once a root cause of the undesired behavior is found from the diagnosis of the undesired behavior, a service update may be generated by the edge orchestrator. The service update may be transferred to the data processing system with the undesired behavior. The service update may be applied to the service of the data processing behavior.

By applying the service update, operation of the data processing system may be improved. By generating compliant data logs, a root cause of the undesired behavior may be found with which the service update may be generated. Thus, computer implemented services may be improved by enforcing generation of compliant data logs by services in data processing systems.

In an embodiment, a method for managing operation of a data processing system of a deployment is disclosed. The method may include (i) obtaining at least one non-compliant log from at least one service hosted by the data processing system; (ii) obtaining, using data log handling rules aligned with a data log schema, at least one compliant log that is based on the at least one non-compliant log; (iii) providing the at least one compliant log to a remote management entity; (iv) obtaining, from the remote management entity and responsive to the at least one compliant log, an update; and (v) updating operation of the data processing system based on the update to facilitate provisioning of computer implemented services using the data processing system.

The method may include, before obtaining the at least one non-compliant log, (i) obtaining, by the remote management entity, requirements for recording an event of the data processing system; (ii) obtaining, based on the requirements, a data log schema; (iii) updating operation of the remote management entity, based on the data log schema, to read data from the at least one compliant log that has a format and pre-determined content that aligns with the data log schema; and (iv) providing, by the remote management entity and to the data processing system, the data log schema to initiate configuration of the data processing system to generate compliant logs.

The data log schema may be a data structure that comprises a standardized set of the requirements for event logging to be used in the data processing system that provides one or more types of services.

The requirements for recording the event of the data processing system may be enforced on a remaining set of data processing systems of the deployment so that data logs of the data processing systems can be analyzed in a similar manner and a pattern of the data log for a first data processing system may be similar to the pattern of the data log for a second data processing system when both the first data processing system and the second processing system encounter a similar problem.

Obtaining the at least one compliant log that is based on the at least one non-compliant log may include (i) obtaining first data from the at least one non-compliant log; (ii) performing data derivation on at least a portion of the first data to obtain second data that complies with requirements of the data log schema; and (iii) obtaining, using the first data, the second data, and the data log handling rules, the at least one compliant log that follows the requirements of the data log schema.

The at least one compliant log may be in a compressed format.

The data log handling rules may include instructions for parsing the at least one non-compliant log to obtain the second data and adding the second data to the at least one compliant log.

Updating the operation of the data processing system may include (i) obtaining, by the data processing system and from the remote management entity, the update; and (ii) performing, using instructions from the update, at least one modification to least one service of the data processing system.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

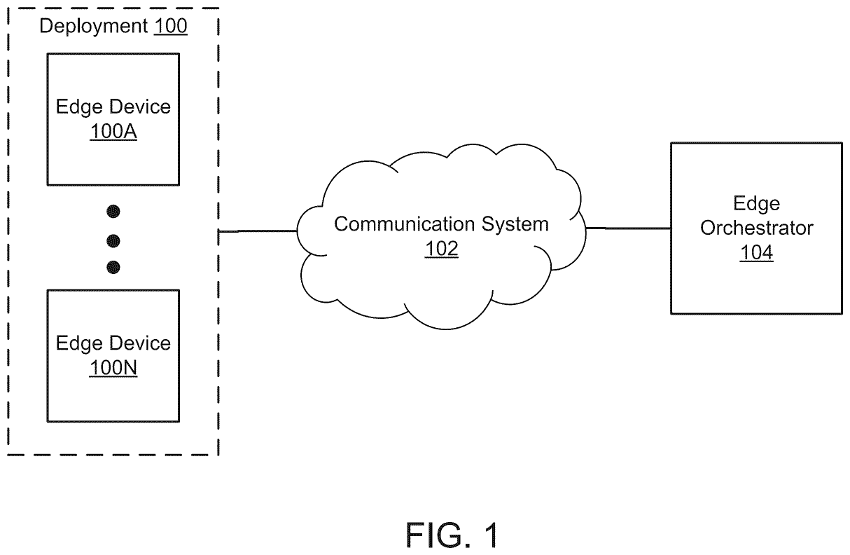

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, data processing systems need to operate in particular manners. However, if the data processing systems do not operate in the particular manners, then the data processing systems may be unable to provide the desired computer implemented services.

In general, embodiments disclosed here relate to systems and methods for managing operation of a data processing system of a deployment. The operation of the data processing systems may be managed by identifying and remediating issues impacting the operation of the data processing systems. By remediating the issues, the operation of the data processing systems may be more likely to match that required to provide desired computer implemented services.

To identify and remediate the issues, logs reflecting operation of the data processing systems over time may be obtained and used to manage the data processing systems. For example, the logs may be used to identify issues (e.g., security threats, errors in operation, etc.) impacting the data processing systems, and identify actions to be performed to address the issues.

To facilitate identification and remediation, data log schemas for data logs generated by data processing systems may be enforced. The data log schemas may specify, for example, how logs are to be generated, content of the logs, formats of the logs, etc. By enforcing the data log schema, logs may be collected, interpreted, and/or stored in a standardized manner across data processing systems. Further, the standardization of the logs may allow for insights obtained through analysis of one system to be used to manage other systems.

Collection of data logs may include conversion of a non-compliant data log from a service in a data processing system to a compliant data log. The compliant data log may adhere to requirements in the data log schema. The service may write data regarding details of an at least one event occurring during provision of the service. For example, an instant messaging service may provide data that includes usernames, source internet protocol (IP) addresses, message content, timestamps of messages, etc. The instant messaging service may also write events that occurred in which a user executed programs to gain access to data about other users. Also, a database management service may provide data that includes usernames, transaction identifications, search entries, etc. The database management service may also write events in which a user attempted to perform transactions for which the user did not have proper authorization. The data logs between the instant messaging service and the database management service, on which the data and/or the events are written, may have different pre-determined formats that do not conform to a standardized format. Thus, the data logs may be non-compliant data logs.

To generate compliant data logs between both services, the data and/or events that meet requirements of the data log schema may be extracted from the non-compliant logs. Further, second data may be derived from the data and/or the events that also meet requirements of the data log schema. The data and the second data that meet requirements of the data log schema may include usernames, source IP addresses, user inputs, commands, timestamps for user login, logout and/or the commands, etc. The events that meet the requirements of the data log schema may include event categories (warnings, errors, success audits, failure audits, etc.) that describe events, messages from events, etc. The compliant data logs may include the data and/or the events that are consistently categorized between the services.

With the compliant data logs, analytics may be performed for the services on at least one data processing system. The analytics may be performed because data structures in the compliant data logs are standardized. As a result, data aggregations, comparisons, trend analytics, and/or other analysis may be performed. Further, the compliant data logs may be used for system monitoring. The system monitoring may be used to diagnose issues across the services to trace for root problems in at least one data processing system. Finally, as more services are incorporated in at least one data processing system, enforcing use of compliant data logs allows scaling the data processing system and the deployment without changes to data logging procedures.

Finally, storing of the compliant data logs may allow for long term data retention and historical analyses. For example, an administrator of the deployment may use compliant data logs to track trends, understand historical performance, and make updates to the deployment based on past compliant data logs. Depending on a usage and timestamping of the compliant data logs, a portion of the compliant data logs that are accessed frequently may be stored in warm storage. However, to archive data that are not accessed frequently and save on computing resources, a second portion of the compliant data logs may be stored in cold storage.

By enforcing a data log schema in the data processing systems in a deployment, compliant data logs may be generated from non-compliant data logs. The compliant data logs may improve computer implemented services by standardizing collection, interpretation, and storage of data across services in at least one data processing system. With the standardization, system monitoring and analytics may more effectively be performed in the data processing systems in the deployment.

To provide the above noted functionality, the system may include deployment 100 and edge orchestrator 104. Each of these components is discussed below.

Deployment 100 may provide desired computer implemented services. To do so, deployment 100 may include any number of edge device 100A-100N. Edge device 100A-100N may be responsible for generating a compliant data log from a non-compliant data log that is generated by a service. The compliant data log may be generated by enforcing, by any number of edge device 100A-100N, data handling rules with data from a non-compliant data log. The compliant data log may be transferred to edge orchestrator 104. From edge orchestrator 104, an update may be received by the any number of edge device 100A-100N.

The update may be based on an analysis of an undesired behavior of any number of edge device 100A-100N. The analysis of the undesired behavior may be based on at least one pattern found in compliant data logs. The update may include at least one modification to at least one service in any number of edge device 100A-100N.

Edge orchestrator 104 may (i) receive compliant data logs from the any number of edge device 100A-100N and (ii) perform an analysis of an operation of the any number of edge device 100A-100N. To perform the analysis, data from the compliant data logs may be disseminated into separate datasets for each category of data and/or type of event. Edge orchestrator 104 may perform analyses on the separate datasets of the data and events within one or more categories. The analysis may be used to diagnose an undesired behavior exhibited by any number of edge device 100A-100N. Edge orchestrator 104 may generate a diagnosis for the undesired behavior. As a result of the diagnosis, edge orchestrator 104 may generate the update. Edge orchestrator 104 may transfer the update to any number of edge device 100A-100N.

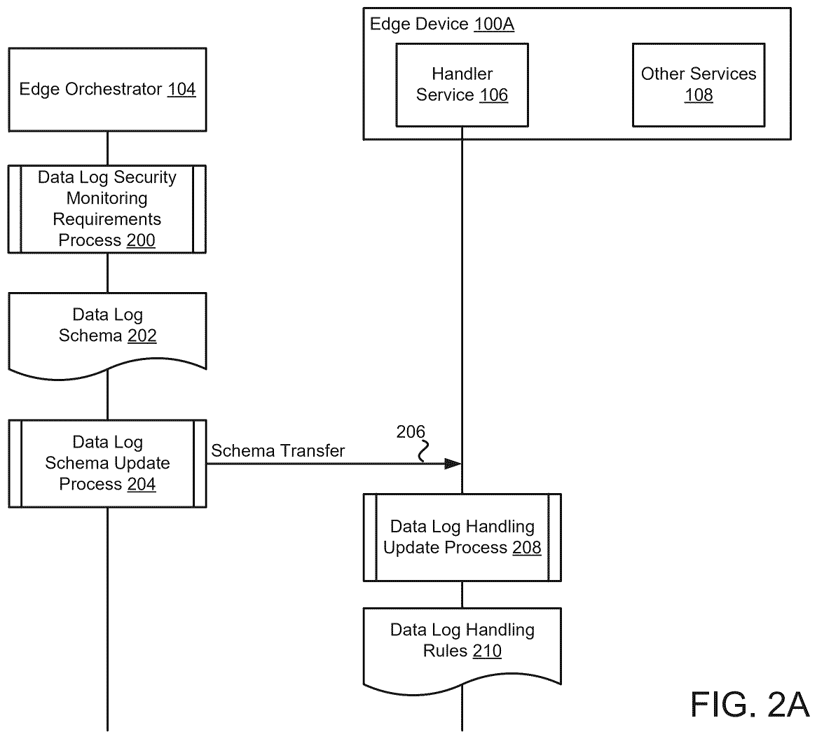

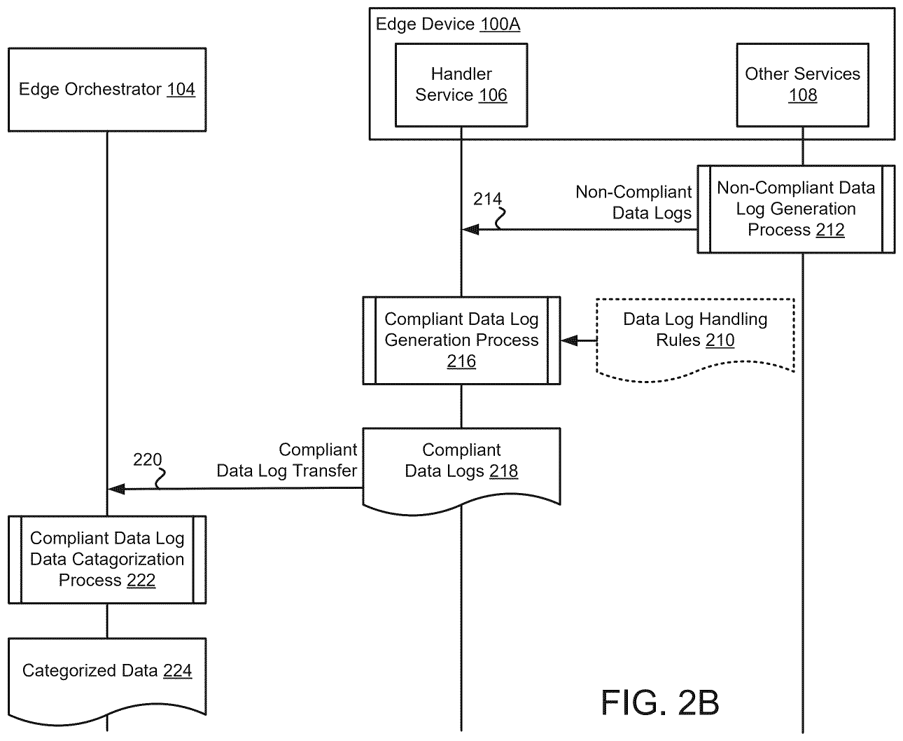

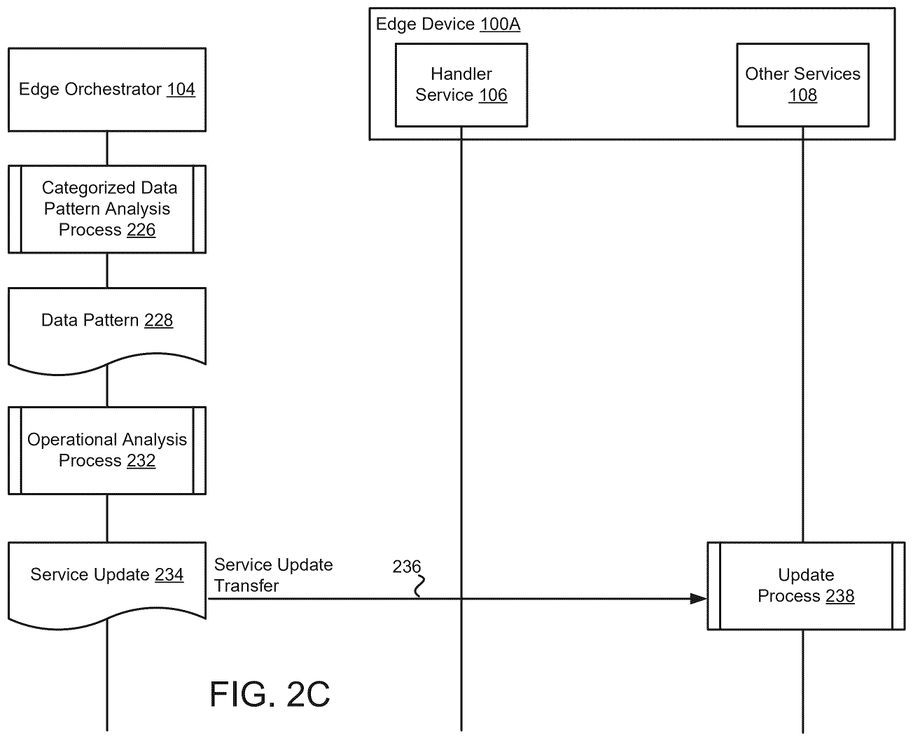

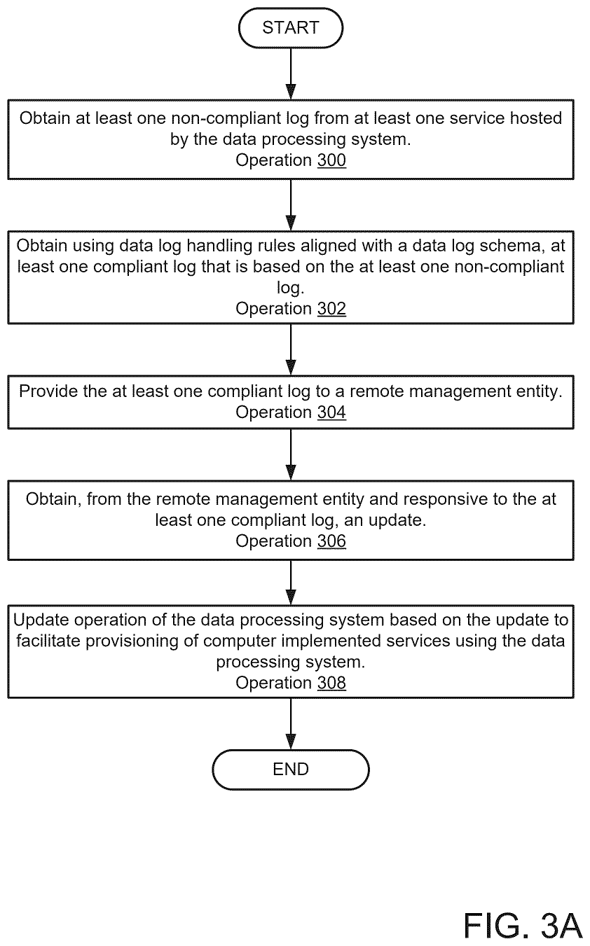

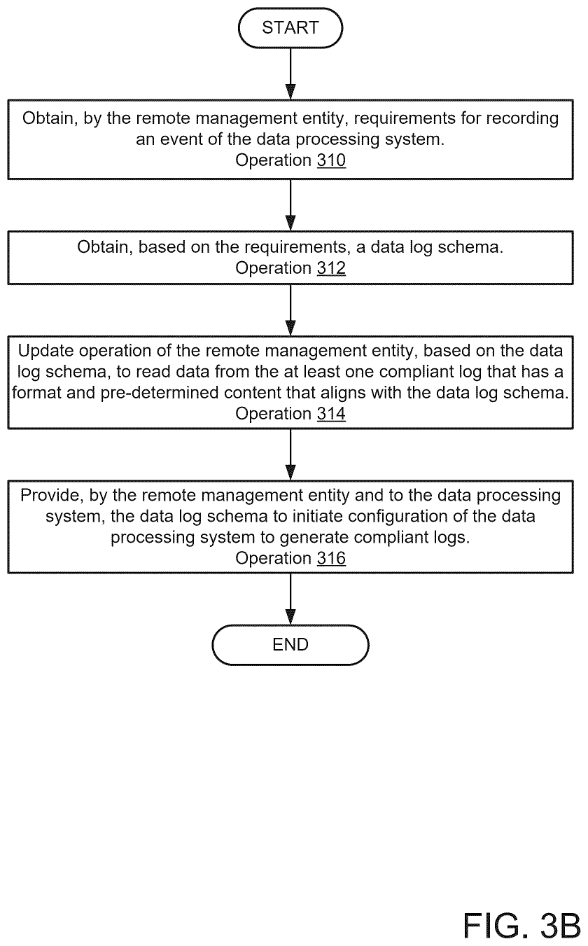

While providing their functionality, any of deployment 100 and edge orchestrator 104 104 may perform all, or a portion, of the flows and methods shown in FIGS. 2A-3B.

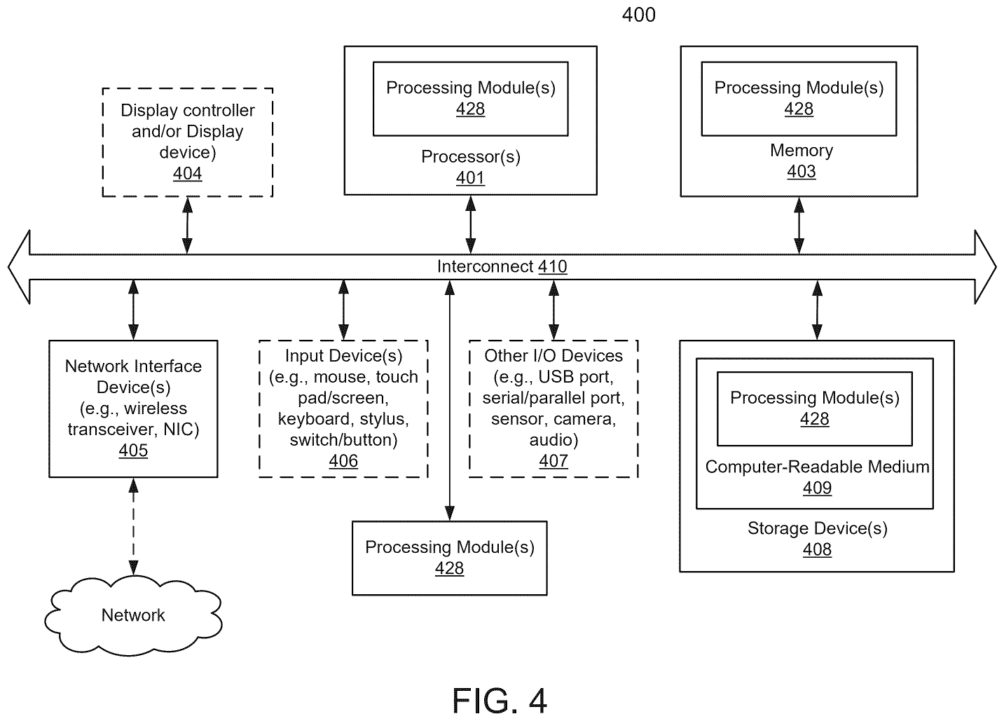

Any of (and/or components thereof) deployment 100 and edge orchestrator 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, interactions diagrams in accordance with an embodiment are shown in FIGS. 2A-2C. These interactions diagrams may illustrate how data may be obtained and used within the system of FIGS. 2A-2C.

In the interaction diagrams, processes performed by and interactions between components of a system in accordance with an embodiment are shown. In the diagrams, components of the system are illustrated using a first set of shapes (e.g., 100A, 104, etc.), located towards the top of each figure. Lines descend from these shapes. Processes performed by the components of the system are illustrated using a second set of shapes (e.g., 226, 232, etc.) superimposed over these lines. Interactions (e.g., communication, data transmissions, etc.) between the components of the system are illustrated using a third set of shapes (e.g., 206, 220, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 206 may occur prior to the interaction labeled as 220. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that occur during transferring data handling rules to edge devices.

To transfer the data handling rules to the edge devices, data log security monitoring requirements process 200 may be performed. During data log security monitoring requirements process 200, requirements for monitoring a security of the edge devices may be received by edge orchestrator 104. The requirements may include (i) categories of data and events to monitor, (ii) compression methods with which to compress logs for storing, transferring, etc., (iii) behavior analytics for processing patterns in data, etc. The requirements may be received from an administrator, a central processing office, a regulatory office, etc.

The requirements may yield data log schema 202. The requirements may yield data log schema 202 by requiring a pre-determined layout for an arrangement for categorized data. The pre-determined layout may be readable by behavior analytics methods for effective processing of the categorized data and be compressible for warm and/or cold storage.

Using data log schema 202, data log schema update process 204 may be performed. During data log schema update process 204, operation of edge orchestrator 104 may be updated so that a data log that complies with data log schema 202 may be read by edge orchestrator 104. The operation may be updated by applying data log requirements, which may include (i) obtaining a file format specification for the compliant data log, (ii) reading example data logs from a compliant data log set, (iii) cataloguing data types from the compliant data log set, (iv) cataloguing field definitions, such as field names, field types, field lengths, and field characters, (v) cataloguing hierarchical relationships (e.g. parent-child) between data elements, (vi) cataloguing mandatory fields and optional fields, (vii) cataloguing validation rules (e.g., ranges for numerical values, allowed values for categorical fields, etc.), (viii) cataloguing fields that must include unique values in an event log within the compliant data log, etc.

Once data log schema update process 204 is complete, at interaction 206, data log schema 202 and the file requirements for data log schema 202 may be transferred to handler service 106 in edge device 100A. Using data log schema 202 and the file requirements for data log schema 202, data log handling update process 208 may be performed.

During data log handling update process 208, operation of handler service 106 may be updated. Operation of handler service 106 may be updated by applying the file requirements for data log schema 202 to a handling operation of non-compliant data logs. The file requirements may be applied by modifying data transformation logic. Modifying the data transformation logic may include (i) using data type conversions, renaming fields, reformatting data values, etc., (ii) modifying how a data log structure is generated, including headers, footers, sections, and/or nested elements, (iii) generating new error handling elements to manage cases where data from a non-compliant data log may not comply with the file requirements of data log schema 202, (iv) generating unit testing to ensure the data transformation logic successfully constructs components of the compliant data log, etc.

From data log handling update process 208, data log handling rules 210 may be generated. Data log handling rules 210 may include (i) the data transformation logic for generating a compliant data log, (ii) at least one unit test and/or integration test to ensure a process of converting a non-compliant data log to a compliant data log performs as expected, (iii) a data structure that includes keywords for fields and/or sections typically in a compliant data log with one or more descriptions for the keywords, and/or (iv) at least one compression method that can compress a file format of the compliant data log before transferring to edge orchestrator 104.

Thus, via the interaction illustrated in FIG. 2A, a system in accordance with an embodiment may transfer the data handling rules to edge devices. Consequently, a deployment (e.g., 100) may be more likely to be able to provide desired computer implemented services by (i) utilizing the requirements of data log schema 202, by edge orchestrator 104, to extract data from the pre-determined file format, and (ii) utilizing data log handling rules 210 to apply new rules for generation of a compliant data log.

Turning to FIG. 2B, a second interaction diagram in accordance with an embodiment is shown. The second interaction diagram may illustrate processes and interactions that occur during transfer and categorization of compliant data logs.

To transfer and categorize the compliant data logs, non-compliant data log generation process 212 may be performed. During non-compliant data log generation process 212, non-compliant data logs may be generated from other services 108. Other services 108 may include services such as instant messaging services, database management services, system monitoring services, etc. Non-compliant data logs may not comply to data log schema 202 because they have a pre-determined layout and/or data categorization that differs from data log schema 202.

For example, from the instant messaging services, a first set of non-compliant data logs may be generated. The first set of non-compliant data logs may include usernames, source IP addresses, messages, etc. From the database management services, a second set of non-compliant data logs may be generated. The second set of non-compliant data logs may include usernames, source IP addresses, command, timestamps for transactions, etc. The first set of non-compliant data logs and the second set of non-compliant data logs may not conform to a standardized layout with identical fields and keywords.

During interaction 214, the non-compliant data logs may be transferred to handler services 106. The non-compliant data logs may be transferred by shared memory, a data stream, message queues, etc. Once the non-compliant data logs are received by handler services 106, compliant data log generation process 216 may be performed.

During compliant data log generation process 216, the data transformation logic from the description of FIG. 2A and data log handling rules 210 may be used after ingestion of the non-compliant data logs to generate the compliant data logs. The data transformation logic may (i) read categories and values from each non-compliant data log of the non-compliant data log, (ii) assign the values to categories in data log schema 202, (iii) convert the values, if necessary, to an expected type (string, integer, float, etc.) for each category of the categories, (iv) derive data for categories in the compliant data log if a similar category is not present in the non-compliant data log, and (v) write the compliant data log.

For example, a first non-compliant data log that recorded instant messaging services may include categories such as usernames, source IP addresses, messages, etc. A second non-compliant data log may that recorded database management services may include usernames, source IP addresses, command, timestamps for transactions, etc.

A first compliant data log for the instant messaging services may extract directly the usernames and source IP addresses directly from the first non-compliant data log. However, a field for the messages may not be included in the first compliant data log. Instead, the first compliant data log may write (i) a program used to generate and sent the message, (ii) the command by the program, (iii) the messages as input data, and (iv) the timestamps of the messages.

Similarly, a second compliant data log for the database management services may extract the usernames and source IP addresses from the second non-compliant data log. Also, a field for the timestamps may be present in the compliant data log so the timestamps may be extracted from the non-compliant data log and written to the compliant data log. In addition, fields for the program and the command may also be present in the compliant data log so the command may also be extracted from the non-compliant data log and written to the compliant data log. Finally, the input data from the program may be written to the compliant data log.

As a result, compliant data logs 218 may be generated from compliant data log generation process 216. In the above example, the first compliant data log and the second compliant data log may both include a standardized set of categories: usernames, source IP addresses, program, command, input data for the program, and timestamps. By including the standardized set of categories, the first compliant data log and the second compliant data log may both conform to requirements of data log schema 202.

After generating compliant data logs, at interaction 220, the compliant data logs may be transferred to edge orchestrator 104. The compliant data logs may be transferred by shared memory, a data stream, message queues, etc. Once the compliant data logs are received by edge orchestrator 104, compliant data log data categorization process 222 may be performed.

During compliant data log data categorization process 222, components of the compliant data logs may be disseminated into separate data structures. The data structures may include the components that are labeled with categories. The categories may also include types of events in the compliant data log.

Disseminated data from compliant data logs 218 may be categorized data 224. For example, the categories (usernames, source IP addresses, program, command, input data for the program, and/or timestamps) may include informational notification. The compliant data logs may include output from programs run by other services 108 that may be classified as warnings, errors, success audits, and failure audits. For example, the first compliant data log from the instant messaging service may include a warning event that (i) a user sent a program with malicious code as input data and (ii) the malicious code was found by the instant messaging service. In a second example, the second compliant data log from the database management service may include failure audit that informs of an audited transaction in a database that failed to complete.

Thus, via the interaction illustrated in FIG. 2B, a system in accordance with an embodiment may transfer of compliant data logs 218 from edge device 100A to edge orchestrator 104, and categorize data and event logs from compliant data logs 218. Consequently, a deployment (e.g., 100) may be more likely to be able to provide desired computer implemented services by standardizing data within data logs and extracting the data according to categorization of the data.

Turning to FIG. 2C, a third interaction diagram in accordance with an embodiment is shown. The third interaction diagram may illustrate processes and interactions that occur during updating operation of other services 108.

To update the operation of other services 108, categorized data pattern analysis process 226 may be performed. During categorized data pattern analysis process 226, data and events within compliant data logs 218 may be analyzed. The data and the events may be analyzed by performing pattern detection the data and the events. The pattern detection may be performed using (i) statistical analysis to detect anomalies and trends, (ii) correlation analysis to identify cause-and-effect; (iii) time-series analysis to detect patterns over time, (iv) machine learning algorithms that use clustering, classification, and anomaly detection, (v) rule-based analysis that trigger alerts when rules are broken and/or thresholds are exceeded, etc.

From categorized data pattern analysis process 226, data pattern 228 may be generated. Data pattern 228 may be a data structure that includes a data set. The data set may include at least one categorized set of data and/or a series of the events. The at least one categorized set of data and/or the series of the events may demonstrate (i) an anomaly and/or a trend, (ii) a correlation within the at least one categorized set of data and/or the series of the event logs, (iii) a pattern over a time series, (iv) at least one rule broken and/or at least one threshold exceeded in the at least one categorized set of data and/or the series of the event logs, etc.

Using data pattern 228, operational analysis process 232 may be performed. During operational analysis process 232, behavior classification may be performed. The behavior classification may include determining a behavior from data pattern 228. The behavior may be determined by correlating a classified behavior with data pattern 228. Examples of classified behaviors may include normal operating behavior, potential risk behavior, performance degradation behavior and/or security threat behavior. Correlating the classified behavior with data pattern 228 may include performing behavior modeling. Behavior modeling techniques may include user behavior modeling, network behavior modeling, application performance modeling, resource utilization modeling, system behavior modeling, etc. A behavior modeling technique may ingest data pattern 228 to trigger a response. For example, ingesting user behavior data, which includes attempted logins from unverified IP addresses, from data pattern 228 may trigger, by the behavior modeling technique, requirements for additional login information. The additional login information may include requiring answers to additional security questions from a user, input of a code from a two-factor authentication method by the user, etc.

Based on at least one response determined from operational analysis process 232, service update 234 may be generated. Service update 234 may include modifications to source code and/or a configuration used by at least one service. The source code and/or the configuration may be modified by generating changes for the source code and/or the configuration. The changes may improve operational behavior of the service. For example, a patch may include the changes to the source code and/or the configuration. The patch, once received by the at least one service, may be ingested by the service. Upon ingesting the patch, the source code and/or the configuration may be modified to improve an operational behavior of the at least one service.

To send service update 234 to the at least one service of other services 108, at interaction 236, service update transfer may be performed. Service update transfer may be performed by shared memory, a data stream, message queues, etc. Once service update 234 is transferred to other services 108, update process 238 may be performed.

During update process 238, the changes to the source code and/or the configuration may be ingested by other services 108. The changes may modify the operational behavior of the at least one service of other services 108. For example, the at least one service may now require at least two inputs to verify users from unverified IP addresses: (i) a username and password and/or (ii) input of a code from a two-factor authentication method by a user.

Thus, via the interaction illustrated in FIG. 2C, a system in accordance with an embodiment may update the operation of other services 108. Consequently, a deployment (e.g., 100) may be more likely to be able to provide desired computer implemented services by (i) performing pattern detection using the data and the event logs from compliant data log 218, (ii) determining a behavior based on an operational analysis of the pattern, and (iii) performing an update to the at least one service of other services 108 based on the behavior of the at least one service.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to managing operation of a data processing system. FIGS. 3A-3B illustrate a method that may be performed by the components of the system of FIG. 1. In the diagrams discussed below and shown in FIG. 3A-3B, any of the operations may be repeated, performed in different orders, and/or performed in parallel with or in a partially overlapping in time manner with other operations.

Turning to FIG. 3A, a flow diagram illustrating a method of managing operation of a data processing system in accordance with an embodiment is shown. The method may be performed, for example, by any of the components of the system of FIG. 1, and/or other components not shown therein.

At operation 300, at least one non-compliant log may be obtained from at least one service hosted by the data processing system. The at least one non-compliant log may be obtained by receiving the at least one non-compliant log from the at least one service.

At operation 302, at least one compliant log that is based on the at least one non-compliant log may be obtained using data log handling rules aligned with a data log schema. The at least one compliant log may be obtained by (i) obtaining first data from the at least one non-compliant log, (ii) performing data derivation on at least a portion of the first data to obtain second data that complies with requirements of the data log schema; and (iii) obtaining, using the first data, the second data, and the data log handling rules, the at least one compliant log that follows the requirements of the data log schema.

The first data may be obtained by extracting the first data from the at least one non-compliant log. The first data may be in a first set of categories related to the at least one service. The data derivation may be performed on at least a portion of the first data by ingesting the at least the portion of the first data in at least one computational and/or machine learning algorithm to generate the second data. The second data may comply with the requirements because the second data may be categorized by keywords enumerated in the requirements. The at least one compliant log may be obtained by writing, using the data log handling rules, the first data and the second data in a layout prescribed the data log schema.

At operation 304, the at least one compliant log may be provided to a remote management entity. The at least one compliant log may be provided by transferring the at least one compliant log. The at least one compliant log may be transferred by shared memory, a data stream, message queues, etc.

At operation 306, an update may be obtained from the remote management entity and responsive to the at least one compliant log. The update may be obtained by transferring the update from the remote management entity to the data processing system. The update may be transferred by transferred by shared memory, a data stream, message queues, etc.

At operation 308, an operation of the data processing system may be updated based on the update to facilitate provisioning of computer implemented services using the data processing system. The operation may be updated by (i) obtaining, by the data processing system and from the remote management entity, the update and (ii) performing, using instructions from the update, at least one modification to at least one service of the data processing system.

The update may be obtained by receiving, by the data processing system, the update from the remote management entity. The at least one modification to least one service may be performed by obtaining, from the instructions, changes for a source code and/or configuration of the operation of the at least one service and writing the changes to the source code and/or the configuration of the operation.

The method may end following operation 308.

Thus, via the method shown in FIG. 3A, embodiments herein may likely improve a likelihood of managing operation of a data processing system. By improving the likelihood of managing operation of a data processing system, the data processing systems may be more likely to provide desirable computer implemented services by, for example, generating compliant logs to standardize data from non-compliant logs, generating an update to operation of services using behaviors determined from the compliant logs, etc.

Turning to FIG. 3B, a flow diagram illustrating a method of managing operation of a data processing system in accordance with an embodiment is shown. The method may be performed, for example, by any of the components of the system of FIG. 1, and/or other components not shown therein. The method in FIG. 3B may be performed before the method of FIG. 3A.

At operation 310, requirements for recording an event of the data processing system may be obtained by the remote management entity. The requirements may be obtained by receiving the requirements from an administrator, a regulatory authority, etc.

At operation 312, a data log schema, based on the requirements, may be obtained. The data log schema may be obtained by obtaining, by the requirements, a pre-determined arrangement of data. The pre-determined arrangement may include categories in which the data and events are enumerated.

At operation 314, operation of the remote management entity may be updated based on the data log schema to read data from the at least one compliant log that has a pre-determined layout and content that aligns with the data log schema. The operation may be updated by applying the requirements to reading a log that complies with the data log schema. Reading the log, by the remote management entity, may include (i) ingesting test logs that comply with the data log schema, (ii) extracting data based on categories in the data log schema, and (iii) aggregating the data in a layout by which to report behavior of the data.

At operation 316, the data log schema may be provided, by the remote management entity and to the data processing system, to initiate configuration of the data processing system to generate compliant logs. The data log schema may be provided by transferring the data log schema from the remote management entity to the data processing system. The data log schema may be transferred by shared memory, a data stream, message queues, etc.

The method may end following operation 316.

Thus, via the method shown in FIG. 3B, embodiments herein may likely improve a likelihood of managing operation of a data processing system. By improving the likelihood of managing operation of a data processing system, the data processing systems may be more likely to provide desirable computer implemented services by, for example, facilitating configuration of the remote management entity to read data from compliant logs, initiating configuration of the data processing system to generate the compliant logs, etc.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing operation of a data processing system of a deployment, the method being performed by the data processing system and comprising:
obtaining at least one non-compliant log from at least one service hosted by the data processing system;
obtaining, using data log handling rules aligned with a data log schema, at least one compliant log that is based on the at least one non-compliant log;
providing the at least one compliant log to a remote management entity, the remote management entity being separate and remotely located from the data processing system;
obtaining, from the remote management entity and responsive to the at least one compliant log, an update; and
updating operation of the data processing system based on the update to facilitate provisioning of computer implemented services using the data processing system.

2. The method of claim 1, further comprising:
before obtaining the at least one non-compliant log:
obtaining, by the remote management entity, requirements for recording an event of the data processing system;
obtaining, based on the requirements, a data log schema;
updating operation of the remote management entity, based on the data log schema, to read data from the at least one compliant log that has a format and pre-determined content that aligns with the data log schema; and
providing, by the remote management entity and to the data processing system, the data log schema to initiate configuration of the data processing system to generate compliant logs.

3. The method of claim 2, wherein the data log schema is a data structure that comprises a standardized set of the requirements for event logging to be used in the data processing system that provides one or more types of services.

4. The method of claim 2, wherein the requirements for recording the event of the data processing system are enforced on a remaining set of data processing systems of the deployment so that data logs of the data processing systems can be analyzed in a similar manner and a pattern of the data log for a first data processing system may be similar to the pattern of the data log for a second data processing system when both the first data processing system and the second data processing system encounter a similar problem.

5. The method of claim 1, wherein obtaining the at least one compliant log that is based on the at least one non-compliant log comprises:
obtaining first data from the at least one non-compliant log;
performing data derivation on at least a portion of the first data to obtain second data that complies with requirements of the data log schema; and
obtaining, using the first data, the second data, and the data log handling rules, the at least one compliant log that follows requirements of the data log schema.

6. The method of claim 5, wherein the at least one compliant log is in a compressed format.

7. The method of claim 5, wherein the data log handling rules comprise instructions for parsing the at least one non-compliant log to obtain the second data and adding the second data to the at least one compliant log.

8. The method of claim 1, wherein updating the operation of the data processing system comprises:
obtaining, by the data processing system and from the remote management entity, the update; and
performing, using instructions from the update, at least one modification to least one service provided by the data processing system, the at least one modification comprises a modification to a source code or a configuration of the data processing system that is associated with the at least one service provided by the data processing system.

9. A non-transitory machine-readable medium having instructions stored therein, which when executed by a processor of a data processing system of a deployment, cause the processor to perform operations for managing operation of the data processing system, the operations comprising:
obtaining at least one non-compliant log from at least one service hosted by the data processing system;
obtaining, using data log handling rules aligned with a data log schema, at least one compliant log that is based on the at least one non-compliant log;
providing the at least one compliant log to a remote management entity, the remote management entity being separate and remotely located from the data processing system;
obtaining, from the remote management entity and responsive to the at least one compliant log, an update; and
updating operation of the data processing system based on the update to facilitate provisioning of computer implemented services using the data processing system.

10. The non-transitory machine-readable medium of claim 9, wherein the operations further comprise:
before obtaining the at least one non-compliant log:
obtaining, by the remote management entity, requirements for recording an event of the data processing system;
obtaining, based on the requirements, a data log schema;
updating operation of the remote management entity, based on the data log schema, to read data from the at least one compliant log that has a format and pre-determined content that aligns with the data log schema; and
providing, by the remote management entity and to the data processing system, the data log schema to initiate configuration of the data processing system to generate compliant logs.

11. The non-transitory machine-readable medium of claim 10, wherein the data log schema is a data structure that comprises a standardized set of the requirements for event logging to be used in the data processing system that provides one or more types of services.

12. The non-transitory machine-readable medium of claim 10, wherein the requirements for recording the event of the data processing system are enforced on a remaining set of data processing systems of the deployment so that data logs of the data processing systems can be analyzed in a similar manner and a pattern of the data log for a first data processing system may be similar to the pattern of the data log for a second data processing system when both the first data processing system and the second data processing system encounter a similar problem.

13. The non-transitory machine-readable medium of claim 9, wherein obtaining the at least one compliant log that is based on the at least one non-compliant log comprises:
obtaining first data from the at least one non-compliant log;
performing data derivation on at least a portion of the first data to obtain second data that complies with requirements of the data log schema; and
obtaining, using the first data, the second data, and the data log handling rules, the at least one compliant log that follows requirements of the data log schema.

14. The non-transitory machine-readable medium of claim 13, wherein the at least one compliant log is in a compressed format.

15. A data processing system, comprising:
a processor; and
a memory coupled to the processor to store instructions, which when executed by the processor, cause the processor of the data processing system to perform operations for managing operation of the data processing system of a deployment, the operations comprising:
obtaining at least one non-compliant log from at least one service hosted by the data processing system;
obtaining, using data log handling rules aligned with a data log schema, at least one compliant log that is based on the at least one non-compliant log;
providing the at least one compliant log to a remote management entity, the remote management entity being separate and remotely located from the data processing system;
obtaining, from the remote management entity and responsive to the at least one compliant log, an update; and
updating operation of the data processing system based on the update to facilitate provisioning of computer implemented services using the data processing system.

16. The data processing system of claim 15, wherein the operations further comprise:
before obtaining the at least one non-compliant log:
obtaining, by the remote management entity, requirements for recording an event of the data processing system;
obtaining, based on the requirements, a data log schema;
updating operation of the remote management entity, based on the data log schema, to read data from the at least one compliant log that has a format and pre-determined content that aligns with the data log schema; and
providing, by the remote management entity and to the data processing system, the data log schema to initiate configuration of the data processing system to generate compliant logs.

17. The data processing system of claim 16, wherein the data log schema is a data structure that comprises a standardized set of the requirements for event logging to be used in the data processing system that provides one or more types of services.

18. The data processing system of claim 16, wherein the requirements for recording the event of the data processing system are enforced on a remaining set of data processing systems of the deployment so that data logs of the data processing systems can be analyzed in a similar manner and a pattern of the data log for a first data processing system may be similar to the pattern of the data log for a second data processing system when both the first data processing system and the second data processing system encounter a similar problem.

19. The data processing system of claim 15, wherein obtaining the at least one compliant log that is based on the at least one non-compliant log comprises:
obtaining first data from the at least one non-compliant log;
performing data derivation on at least a portion of the first data to obtain second data that complies with requirements of the data log schema; and
obtaining, using the first data, the second data, and the data log handling rules, the at least one compliant log that follows requirements of the data log schema.

20. (canceled)

21. The method of claim 1, wherein the at least one non-compliant data log is generated by the data processing system in a format that is non-complaint with how data logs of the data processing system should be generated.
